(19) United States
(12) Patent Application Publication
(10) Pub. No.: US 2014/0137468 A1
(43) Pub. Date: May 22, 2014

(54) Portable Solar Modular Greenhouse

(71) Applicant: Gregory M. Ching, Nederland, CO (US)

(72) Inventor: Gregory M. Ching, Nederland, CO (US)

(21) Appl. No.: 14/076,048

(22) Filed: Nov. 8, 2013

Related U.S. Application Data
(60) Provisional application No. 61/796,412, filed on Nov. 9, 2012.

(51) Int. Cl. A01G 9/14

(52) U.S. Cl. CPC A01G 9/14
USPC 47/17

(57) ABSTRACT

The customizable collapsible greenhouse of the invention comprises a T-slot aluminum frame, SolaWrap™ panels, and a variety of other components including rainwater capture, remote sensing, vermiculture, composting, and solar generation of electricity.

### CLAIM OF PRIORITY

This patent application claims priority under 35 USC 119 (e) (1) from U.S. Provisional Patent Application Ser. No. 61/796,412 filed Nov. 9, 2012, of Greg M. Ching et al, entitled “Modular Solar Greenhouse Devices, Systems and Methods for Growing Plants that Address Food, energy, Water and Community Concerns.”

### FIELD OF THE INVENTION

This invention pertains to the field of greenhouses, and more specifically to the field of solar greenhouses and even more specifically to the field of modular solar greenhouses and even more specifically to field of remotely sensed and controlled modular solar greenhouses.

### BACKGROUND OF THE INVENTION

The prior art has put forth several devices in the field of solar greenhouses. Among these are:

U.S. Pat. No. 4,462,390 to Robert B. Holdridge et al describes a modular solar greenhouse with elevated overhead heat storage material and movable insulation barriers and method and system for solar heating of attached living space using thermostat-controlled air circulation for harvesting heat.

U.S. Pat. No. 5,101,593 to Kashyap K. B. Bhatt describes a portable solar greenhouse comprising a closed chamber having windows, racks and trays, and wherein solar collection devices power irrigation pumps.

U.S. Pat. No. 4,173,212 to Carl E. Whitcomb describes a self-contained solar greenhouse having rectangular floor, parallel sides and a quonset type roof structure.

U.S. Pat. No. 5,056,259 to William M. Allen describes a solar greenhouse for growing plants comprising peripheral walls and a removable roof.

None of these references describe the present invention. All references cited are incorporated herein by reference to the extent that they are not inconsistent with the disclosure herein.

### SUMMARY OF THE INVENTION

The present invention provides a modular solar self-contained greenhouse comprised of any of a variety of components, collectively referred to as portable solar modular greenhouse, hereinafter sometimes referred to as PSMG, or greenhouse. These components include: an expandable small footprint greenhouse structure comprising one or more connected modules, transparent or translucent multi wall siding comprising polyethylene panels such as SolaWrap™ for light capture with insulation, magnetized sectional insulation for glazing control and cold weather gardening, LED lights comprising low wattage lights such as 9 watt or lower wattage LED light strips in blue and red. These lights can be mounted vertically along the inside of the greenhouse, or can be mounted on the ceiling of the greenhouse, temperature sensitive ventilation (both powered and unpowered), extruded hollow aluminum T-track, or T-slot frame, integrating water pipe, electrical wiring and mechanical tracks, flat shipment easily moveable through a common doorway with easy pull-up hinged assembly, photovoltaic panels both rooftop and remote ground mount for operations and backup power, expandable battery options for night and emergency usage, expandable rainwater collection/diversion with emergency drinking water purification, solar-powered storage water recirculation with filtering, self-watering drip irrigation system (requires external cold water if collected water too warm), integrated composting worm bin (receives drip irrigation drainage/provides “tea” for watering), photosensitive (optionally daylight only) and timer control of lights and pumps, wireless remote monitoring and control of all greenhouse operations, Cloud storage of data logs, foldable and lockable stability legs and hooks for high wind stability, skateboard quality polyurethane lockable casters attached to the bottom of the PSMG, removable base for floor protection, interior ceiling grid supporting vertical gardening hooks, steel encased insulated floor comprising two galvanized steel panels sandwiching rigid foam wherein the current insulation value is R-5 with a fiber insulator between the overlapping two panel edges to minimize thermal bridging, removable interior side shelves to accommodate 6-pack “Nursery Style” seed starter pots, drain controlled tray with removable planter/window box liners, interior lights, each PSMG is capable (with different capacity options) of producing 5V USB, 12V DC, and 110V AC. The “Garden Genie” is a hardware and software system that can collect and manage data in a modular greenhouse environment and send and receive that data via Wi-Fi, Bluetooth or CAT5 to a nearby router for use in a local computer or mobile device, and beyond to an online aggregator web site. Data managed includes one or more of the following:
Wi-Fi Bluetooth or CAT5 enabled
Webcam to record images for time-elapsed video
Powered by DC solar or AC
Temperature
Humidity
Light level (by leaves)
Soil moisture
pH
carbon dioxide
soil temperature
water temperature (in container)
exterior temperature exterior humidity
uses
   i. automated changes to greenhouse conditions
   ii. human can review data and make changes
   iii. share data with others
   iv. analyze and design customized programs
   v. report on history.

Power for the lights and water are supplied by a battery which stores electricity from the solar panels, or from AC grid current, if necessary.

In an embodiment, the systems of this invention include a combination of two or more of any devices or components described above.

In an embodiment, the systems of this invention include a combination of three or more of any devices or components described above.

In an embodiment, the systems of this invention include a combination of four or more of any devices or components described above.

In an embodiment, the systems of this invention include a combination of five or more of any devices or components described above.

In an embodiment, the systems of this invention include a combination of six or more of any devices or components described above.

In an embodiment, two or more modular systems of this invention are combined together to comprise a meta-system.

### BRIEF DESCRIPTION OF THE DRAWINGS

FIG. 1 is front perspective view of a frame of one embodiment of the structure of the greenhouse of the present invention.

FIG. 2 is a side view of a frame of one embodiment of the greenhouse of the present invention.

FIG. 3 is a front view of a frame of one embodiment of the greenhouse of the present invention.

FIG. 4 is a front perspective view of the track of the frame of one embodiment of the greenhouse of the present invention.

FIG. 5 is a flow diagram of the data distribution of the Garden Genie of the present invention for one modular greenhouse.

FIG. 6 is a flow diagram of the data distribution of the Garden Genie of the present invention for an extended greenhouse comprising multiple modules.

FIG. 7 is a cross-sectional view of the frame of the greenhouse of the present invention.

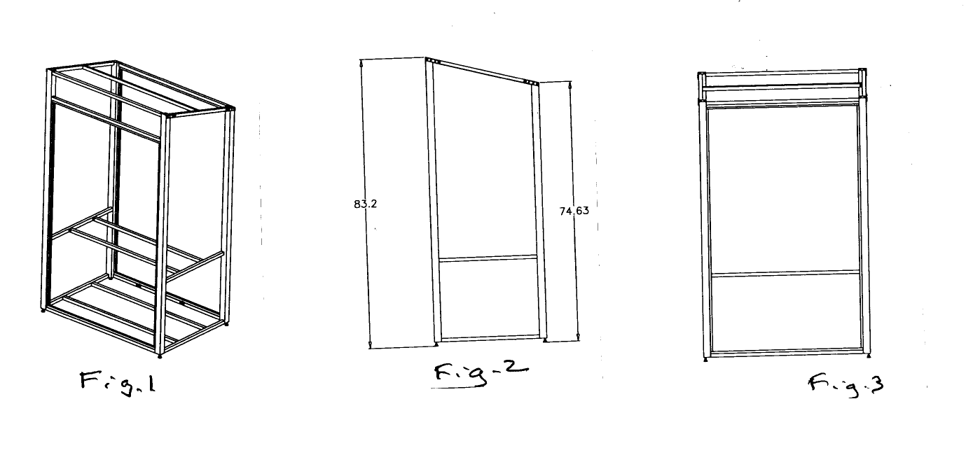

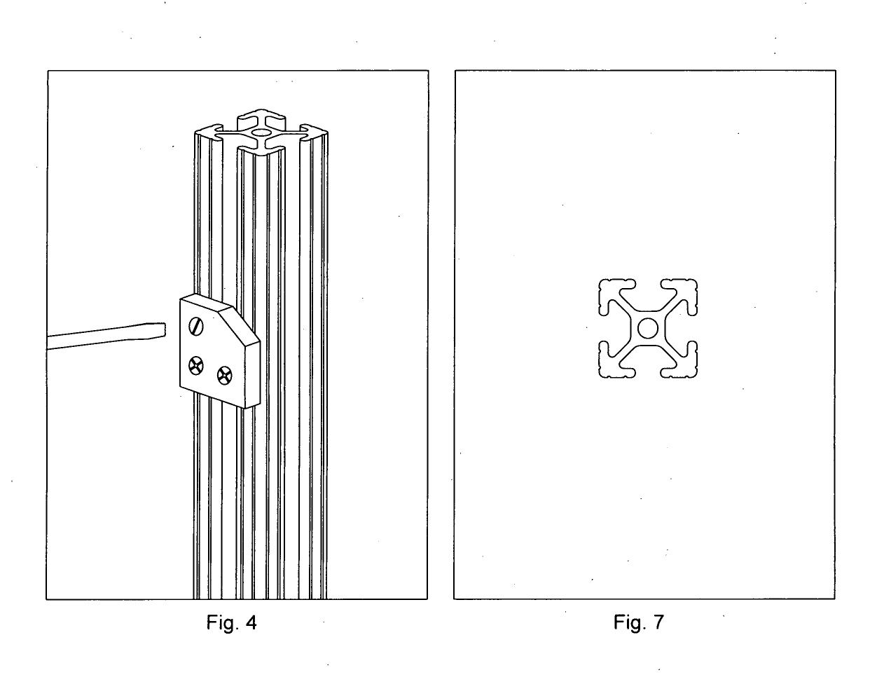

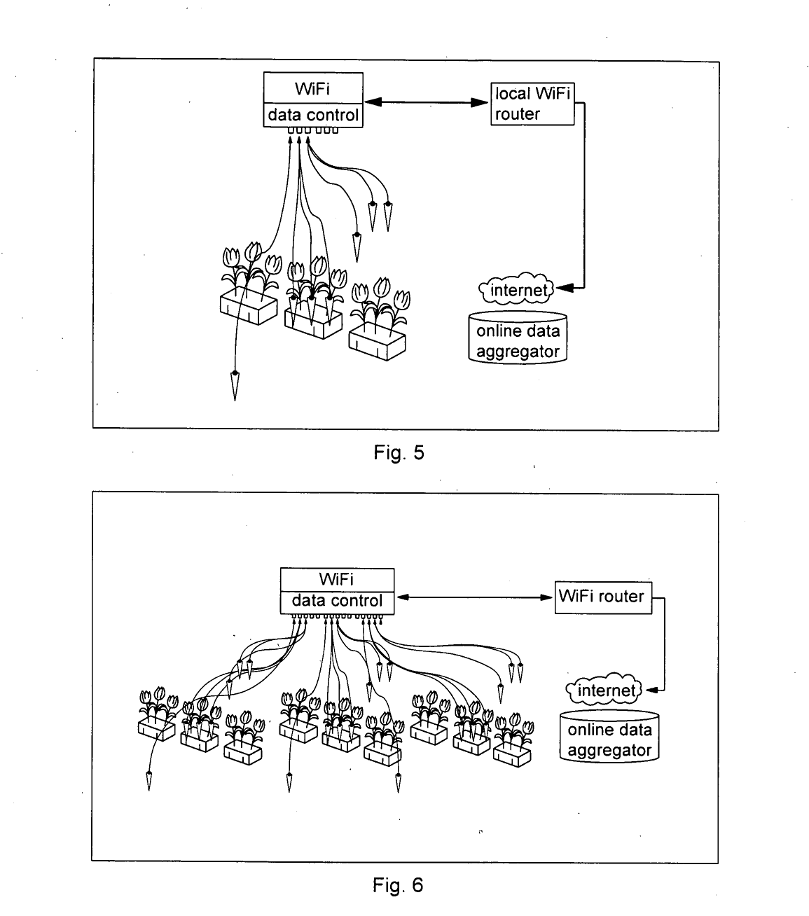

### DETAILED DESCRIPTION OF THE INVENTION

The present invention provides a portable solar modular greenhouse, hereinafter sometimes referred to as PSMG, or greenhouse. The greenhouse of the present invention is designed to meet the individual needs of the user, by incorporating appropriate components to design a greenhouse to accommodate a variety of uses and situations. The greenhouse of the present invention can be designed to be self-sustaining in a disaster situation or for developing country situations; it can be sized to fit on a small patio of a high-rise apartment building. The design can be small to allow the user to lean into the unit to harvest and tend the plants, or it can be large enough to walk in. The modules can be grouped together to afford more growing space and to generate auxiliary power. The present greenhouse comprises one or more of the following components: an expandable small footprint greenhouse structure comprising one or more connected modules, transparent or translucent multi wall siding comprising polyethylene panels such as SolaWrap™ for light capture with insulation, magnetized sectional insulation for glazing control and cold weather gardening, LED lights comprising low wattage lights such as 9 watt or lower wattage LED light strips in blue and red. These lights can be mounted vertically along the inside of the greenhouse, or can be mounted on the ceiling of the greenhouse, temperature sensitive ventilation (both powered and unpowered), extruded hollow aluminum T-track, or T-slot frame, integrating water pipe, electrical wiring and mechanical tracks, flat shipment easily moveable through a common doorway with easy pull-up hinged assembly, photovoltaic panels both rooftop and remote ground mount for operations and backup power, expandable battery options for night and emergency usage, expandable rainwater collection/diversion with emergency drinking water purification, solar-powered storage water recirculation with filtering, self-watering drip irrigation system (requires external cold water if collected water too warm), integrated composting worm bin (receives drip irrigation drainage/provides “tea” for watering), photosensitive (optionally daylight only) and timer control of lights and pumps, wireless remote monitoring and control of all greenhouse operations, Cloud storage of data logs, foldable and lockable stability legs and hooks for high wind stability, skateboard quality polyurethane lockable casters attached to the bottom of the PSMG, removable base for floor protection, interior ceiling grid supporting vertical gardening hooks, steel encased insulated floor comprising two galvanized steel panels sandwiching rigid foam wherein the current insulation value is R-5 with a fiber insulator between the overlapping two panel edges to minimize thermal bridging, removable interior side shelves to accommodate 6-pack “Nursery Style” seed starter pots, drain controlled tray with removable planter/window box liners, interior lights, each PSMG is capable (with different capacity options) of producing 5V USB, 12V DC, and 110V AC. The “Garden Genie” is a hardware and software system that can collect and manage data in a modular greenhouse environment and send and receive that data via Wi-Fi, Bluetooth or CAT5 to a nearby router for use in a local computer or mobile device, and beyond to an online aggregator web site. Data managed includes one or more of the following:
Wi-Fi Bluetooth or CAT5 enabled
Webcam to record images for time-elapsed video
Powered by DC solar or AC
Temperature
Humidity
Light level (by leaves)
Soil moisture
pH
carbon dioxide
soil temperature
water temperature (in container)
exterior temperature
exterior humidity
uses
   i. automated changes to greenhouse conditions
   ii. human can review data and make changes
   iii. share data with others
   iv. analyze and design customized programs
   v. report on history.
      Sensors include:
      Sensors optionally ganged into a single output connector
Interior ambient conditions sensors (designed to share a single input to data control device)
   Interior ambient air temperature sensor
   Interior ambient humidity (air moisture) sensor
   Interior light level sensor
   Carbon dioxide
Soil condition sensors (designed to share a single input to data control device)
   Soil temperature sensor
   Soil pH sensor
   Soil moisture content sensor
Water temperature sensor at the water reclamation container
Exterior conditions sensors (designed to share a single input to data control device) (Note: The author assumes that exterior condition sensors will be identical to those for interior conditions. But exterior sensors are identified here in case their development is significantly different from the interior ambient sensors)
   Exterior air temperature sensor
   Exterior humidity (air moisture) sensor
   Exterior light level sensor.

In an embodiment, the systems of this invention include a combination of two or more of any devices or components described in this invention.

In an embodiment, two or more modular systems of this invention are combined together to comprise a meta-system.

As mentioned earlier, the modules can be customized to meet the user's needs. For example, for a disaster relief or developing country situation, one module can be designed to functions as an internet cafe module. For off-grid living there might be a Solarator™ (solar alternative to backup power generator) and refrigeration module. For mobile applications, the Solarator and refrigeration might be on a truck chassis or trailer of a vehicle.

The solar collector for use with the PSMG can collect solar energy to power not only the PSMG, but also for personal home use. In emergency situations, the PSMG can also integrate with other stand-alone collectors to become a charging station for cell phones, Portable refrigeration and even electric vehicles.

Optionally, My Worm Farmer™, is a large version of the worm composting bin being outside of the PSMG or perhaps a smaller version underneath a kitchen sink. The worm composter comprises a semi-porous container such as bamboo having a semi-porous shelf above a main tray to allow drip irrigation. Compost and at least one worm are placed into the container on top of the tray with the worm being under the compost. Water from the drip irrigation system is allowed to pass over the compost. Water that drips over the compost flows through the compost and the worms and washes nutrients and other organic matter into the main tray, thus creating “compost tea.” The worm is hermaphroditic and will reproduce, thus creating more worms. Worm casings and other compost create excellent potting medium for growing plants.

The rainwater redirection system ensures that rainwater is channeled away from your terrace or deck to hydrate thirsty plants through the automatic watering system. The irrigation reservoir can also provide emergency water when needed.

Rainwater is harvested from roof runoff into a gutter that extends to the corners of the structure. Water is then directed through the central channel of the T-slot frame into a food grade collapsible plastic bladder. One suitable bladder is 90 gallons in capacity, but is maintained at a level of about 53 gallons. In an embodiment, float sensors detect the volume of water. When the water in the bladder falls below 53 gallons, the bladder is manually filled from a hose connected to a water source. The bladder is housed in an insulated box to thermally control the temperature of the water and to prevent freezing. When the Garden Genie senses that the soil around the plants is dry, turns on the pump and water is directed from the bladder through an irrigation system to hydrate the plants.

The integrated automatic drip system uses kitchen scraps and paper to create nutritious compost tea to keep your plants hydrated and nourished.

PSMG is a modular greenhouse designed for both urban and rural environments. In various embodiments, it can be used not only to grow plants but also to create compost, collect and purify rainwater, and generate solar power, all with remote monitoring that allows tracking of the humidity, temperature, light level, and more.

In one embodiment, a PSMG is 48″ wide by 32″ deep by 82″ tall and can fit on a deck just 5 to 6 feet wide. Because it is modular, units can be joined to create a larger greenhouse. The durable, lightweight aluminum frame creates minimal impact on terraces and deck. The unique T-track or T-slot design allows for additional shelves and additional components. A cross-section of the T-slot frame is shown in FIG. 7. Suitable framing is available from a variety of sources, including 80/20 Inc., at http://www.8020.net. The frame supports the highly engineered, triple-layered skin system, SolaWrap™ SolaWrap is available from www.harvestpathwyas.com. This material is lightweight and enables energy to pass through the system at 83% transparency while scattering the light energy with 83% diffusion rate, eliminating burn spots and shadowing. Its thermal resistivity is five times greater than that of other polyethylenes and three times greater than polycarbonates.

In an embodiment the frame which supports the skin system can be collapsible. In an embodiment, the sides, ceiling and floor of the PSMG can be designed so that the user need only lift up on the uppermost component to erect the basic structure of the device.

PSMG is easy to use and self-sufficient. Its sliding panels open automatically as needed to ensure that plants don't get too hot. The remote monitoring features help maintain the correct conditions for plants. With all these features, it is easy to grow all kinds of plants, from mushrooms to cacti. Ornamental flowers, herbs or even food can easily be grown using the PSMG.

Food, energy, water, and community are themes behind the development of PSMG. Although the greenhouse is targeted to take advantage of limited urban space, the technologies integrated into PSMG address issues of urban food production, emergency preparedness, education, and community building even in remote areas.

PSMG support community gardening and production of energy. Community solar (e.g., 10,000 10 kW arrays spread over 50 km versus one centralized 100 MW array) and develop turn-key modular rain-water-collecting, water purifying, vermiculture composting, remote monitoring, solar power generator greenhouses designed for both urban and rural environments. The greenhouse modules will be closet sized but can be locked together to become DC micro grid or net metered AC small community arrays. Some features may require multiple modules. This invention is appealing to those interested in food supply chain security, disaster recovery, and specialty crop growth.

The systems of this invention are useful for germinating and growing plants using soil or in soilless growing. The systems of this invention are used with seeds or plants and optionally sunlight, water and plant food to grow plants.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A modular greenhouse system for growing a plant or germinating a seed into a plant, wherein said system comprises two or more of any combination of the components selected from the group consisting of: an expandable small footprint greenhouse structure comprising one or more connected modules, transparent or translucent multi wall siding comprising polyethylene panels such as SolaWrap™ for light capture with insulation, magnetized sectional insulation for glazing control and cold weather gardening, LED lights comprising low wattage lights such as 9 watt or lower wattage LED light strips in blue and red, wherein the lights can be mounted vertically along the inside of the greenhouse, or can be mounted on the ceiling of the greenhouse, temperature sensitive ventilation (both powered and unpowered), extruded hollow aluminum T-track, or T-slot frame, integrating water pipe, electrical wiring and mechanical tracks, flat shipment easily moveable through a common doorway with easy pull-up hinged assembly, photovoltaic panels both rooftop and remote ground mount for operations and backup power, expandable battery options for night and emergency usage, expandable rainwater collection/diversion with emergency drinking water purification, solar-powered storage water recirculation with filtering, self-watering drip irrigation system (requires external cold water if collected water too warm), integrated composting worm bin (receives drip irrigation drainage/provides “tea” for watering), photosensitive (optionally daylight only) and timer control of lights and pumps, wireless remote monitoring and control of all greenhouse operations, Cloud storage of data logs, foldable and lockable stability legs and hooks for high wind stability, skateboard quality polyurethane lockable casters attached to the bottom of the PSMG, removable base for floor protection, interior ceiling grid supporting vertical gardening hooks, steel encased insulated floor comprising two galvanized steel panels sandwiching rigid foam wherein the current insulation value is R-5 with a fiber insulator between the overlapping two panel edges to minimize thermal bridging, removable interior side shelves to accommodate 6-pack “Nursery Style” seed starter pots, drain controlled tray with removable planter/window box liners, interior lights, each PSMG is capable (with different capacity options) of producing 5V USB, 12V DC, and 110V AC. The “Garden Genie” is a hardware and software system that can collect and manage data in a modular greenhouse environment and send and receive that data via Wi-Fi, Bluetooth or CAT5 to a nearby router for use in a local computer or mobile device, and beyond to an online aggregator web site, and wherein data management includes one or more of the following:
Bluetooth or CAT5 enabled
Webcam to record images for time-elapsed video
Powered by DC solar or AC
Temperature
Humidity
Light level (by leaves)
Soil moisture
pH
carbon dioxide
soil temperature
water temperature (in container)
exterior temperature
exterior humidity
uses
i. automated changes to greenhouse conditions
ii. human can review data and make changes
iii. share data with others
iv. analyze and design customized programs
v. report on history.

2. The modular greenhouse system of claim 1 comprising an aluminum frame structure and one or more components selected from the group consisting of: an expandable small footprint greenhouse structure comprising one or more connected modules, transparent or translucent multi wall siding comprising polyethylene panels such as SolaWrap™ for light capture with insulation, magnetized sectional insulation for glazing control and cold weather gardening, LED lights comprising low wattage lights such as 9 watt or lower wattage LED light strips in blue and red, wherein the lights can be mounted vertically along the inside of the greenhouse, or can be mounted on the ceiling of the greenhouse, temperature sensitive ventilation (both powered and unpowered), extruded hollow aluminum T-track, or T-slot frame, integrating water pipe, electrical wiring and mechanical tracks, flat shipment easily moveable through a common doorway with easy pull-up hinged assembly, photovoltaic panels both rooftop and remote ground mount for operations and backup power, expandable battery options for night and emergency usage, expandable rainwater collection/diversion with emergency drinking water purification, solar-powered storage water recirculation with filtering, self-watering drip irrigation system (requires external cold water if collected water too warm), integrated composting worm bin (receives drip irrigation drainage/provides “tea” for watering), photosensitive (optionally daylight only) and timer control of lights and pumps, wireless remote monitoring and control of all greenhouse operations, Cloud storage of data logs, foldable and lockable stability legs and hooks for high wind stability, skateboard quality polyurethane lockable casters attached to the bottom of the PSMG, removable base for floor protection, interior ceiling grid supporting vertical gardening hooks, steel encased insulated floor comprising two galvanized steel panels sandwiching rigid foam wherein the current insulation value is R-5 with a fiber insulator between the overlapping two panel edges to minimize thermal bridging, removable interior side shelves to accommodate 6-pack “Nursery Style” seed starter pots, drain controlled tray with removable planter/window box liners, interior lights, each PSMG is capable (with different capacity options) of producing 5V USB, 12V DC, and 110V AC. The “Garden Genie” is a hardware and software system that can collect and manage data in a modular greenhouse environment and send and receive that data via Wi-Fi, Bluetooth or CAT5 to a nearby router for use in a local computer or mobile device, and beyond to an online aggregator web site, and wherein data management includes one or more of the following:
Wi-Fi Bluetooth or CAT5 enabled
Webcam to record images for time-elapsed video
Powered by DC solar or AC
Temperature
Humidity
Light level (by leaves)
Soil moisture
pH
carbon dioxide
soil temperature
water temperature (in container)
exterior temperature
exterior humidity
uses
i. automated changes to greenhouse conditions
ii. human can review data and make changes
iii. share data with others
iv. analyze and design customized programs
v. report on history.

3. The modular greenhouse system of claim 1 comprising an aluminum T-track or T-slot frame and two or more components selected from the group consisting of: an expandable small footprint greenhouse structure comprising one or more connected modules, transparent or translucent multi wall siding comprising polyethylene panels such as SolaWrap™ for light capture with insulation, magnetized sectional insulation for glazing control and cold weather gardening, LED lights comprising low wattage lights such as 9 watt or lower wattage LED light strips in blue and red, wherein the lights can be mounted vertically along the inside of the greenhouse, or can be mounted on the ceiling of the greenhouse, temperature sensitive ventilation (both powered and unpowered), extruded hollow aluminum T-track, or T-slot frame, integrating water pipe, electrical wiring and mechanical tracks, flat shipment easily moveable through a common doorway with easy pull-up hinged assembly, photovoltaic panels both rooftop and remote ground mount for operations and backup power, expandable battery options for night and emergency usage, expandable rainwater collection/diversion with emergency drinking water purification, solar-powered storage water recirculation with filtering, self-watering drip irrigation system (requires external cold water if collected water too warm), integrated composting worm bin (receives drip irrigation drainage/provides “tea” for watering), photosensitive (optionally daylight only) and timer control of lights and pumps, wireless remote monitoring and control of all greenhouse operations, Cloud storage of data logs, foldable and lockable stability legs and hooks for high wind stability, skateboard quality polyurethane lockable casters attached to the bottom of the PSMG, removable base for floor protection, interior ceiling grid supporting vertical gardening hooks, steel encased insulated floor comprising two galvanized steel panels sandwiching rigid foam wherein the current insulation value is R-5 with a fiber insulator between the overlapping two panel edges to minimize thermal bridging, removable interior side shelves to accommodate 6-pack “Nursery Style” seed starter pots, drain controlled tray with removable planter/window box liners, interior lights, each PSMG is capable (with different capacity options) of producing 5V USB, 12V DC, and 110V AC. The “Garden Genie” is a hardware and software system that can collect and manage data in a modular greenhouse environment and send and receive that data via Wi-Fi, Bluetooth or CAT5 to a nearby router for use in a local computer or mobile device, and beyond to an online aggregator web site, and wherein data management includes one or more of the following:
Wi-Fi Bluetooth or CAT5 enabled
Webcam to record images for time-elapsed video
Powered by DC solar or AC
Temperature
Humidity
Light level (by leaves)
Soil moisture
pH
carbon dioxide
soil temperature
water temperature (in container)
exterior temperature
exterior humidity
uses
i. automated changes to greenhouse conditions
ii. human can review data and make changes
iii. share data with others
iv. analyze and design customized programs
v. report on history.

4. The modular greenhouse system of claim 1 comprising an aluminum T-slot frame and five or more components selected from the group consisting of: an expandable small footprint greenhouse structure comprising one or more connected modules, transparent or translucent multi wall siding comprising polyethylene panels such as SolaWrap™ for light capture with insulation, magnetized sectional insulation for glazing control and cold weather gardening, LED lights comprising low wattage lights such as 9 watt or lower wattage LED light strips in blue and red, wherein the lights can be mounted vertically along the inside of the greenhouse, or can be mounted on the ceiling of the greenhouse, temperature sensitive ventilation (both powered and unpowered), extruded hollow aluminum T-track, or T-slot frame, integrating water pipe, electrical wiring and mechanical tracks, flat shipment easily moveable through a common doorway with easy pull-up hinged assembly, photovoltaic panels both rooftop and remote ground mount for operations and backup power, expandable battery options for night and emergency usage, expandable rainwater collection/diversion with emergency drinking water purification, solar-powered storage water recirculation with filtering, self-watering drip irrigation system (requires external cold water if collected water too warm), integrated composting worm bin (receives drip irrigation drainage/provides “tea” for watering), photosensitive (optionally daylight only) and timer control of lights and pumps, wireless remote monitoring and control of all greenhouse operations, Cloud storage of data logs, foldable and lockable stability legs and hooks for high wind stability, skateboard quality polyurethane lockable casters attached to the bottom of the PSMG, removable base for floor protection, interior ceiling grid supporting vertical gardening hooks, steel encased insulated floor comprising two galvanized steel panels sandwiching rigid foam wherein the current insulation value is R-5 with a fiber insulator between the overlapping two panel edges to minimize thermal bridging, removable interior side shelves to accommodate 6-pack “Nursery Style” seed starter pots, drain controlled tray with removable planter/window box liners, interior lights, each PSMG is capable (with different capacity options) of producing 5V USB, 12V DC, and 110V AC. The “Garden Genie” is a hardware and software system that can collect and manage data in a modular greenhouse environment and send and receive that data via Wi-Fi, Bluetooth or CAT5 to a nearby router for use in a local computer or mobile device, and beyond to an online aggregator web site, and wherein data management includes one or more of the following:
Wi-Fi Bluetooth or CAT5 enabled
Webcam to record images for time-elapsed video
Powered by DC solar or AC
Temperature
Humidity
Light level (by leaves)
Soil moisture
pH
carbon dioxide
soil temperature
water temperature (in container)
exterior temperature
exterior humidity
uses
i. automated changes to greenhouse conditions
ii. human can review data and make changes
iii. share data with others
iv. analyze and design customized programs
v. report on history.

5. The modular greenhouse system of claim 1 comprising an aluminum T-slot frame and seven or more components selected from the group consisting of: an expandable small footprint greenhouse structure comprising one or more connected modules, transparent or translucent multi wall siding comprising polyethylene panels such as SolaWrap™ for light capture with insulation, magnetized sectional insulation for glazing control and cold weather gardening, LED lights comprising low wattage lights such as 9 watt or lower wattage LED light strips in blue and red, wherein the lights can be mounted vertically along the inside of the greenhouse, or can be mounted on the ceiling of the greenhouse, temperature sensitive ventilation (both powered and unpowered), extruded hollow aluminum T-track, or T-slot frame, integrating water pipe, electrical wiring and mechanical tracks, flat shipment easily moveable through a common doorway with easy pull-up hinged assembly, photovoltaic panels both rooftop and remote ground mount for operations and backup power, expandable battery options for night and emergency usage, expandable rainwater collection/diversion with emergency drinking water purification, solar-powered storage water recirculation with filtering, self-watering drip irrigation system (requires external cold water if collected water too warm), integrated composting worm bin (receives drip irrigation drainage/provides “tea” for watering), photosensitive (optionally daylight only) and timer control of lights and pumps, wireless remote monitoring and control of all greenhouse operations, Cloud storage of data logs, foldable and lockable stability legs and hooks for high wind stability, skateboard quality polyurethane lockable casters attached to the bottom of the PSMG, removable base for floor protection, interior ceiling grid supporting vertical gardening hooks, steel encased insulated floor comprising two galvanized steel panels sandwiching rigid foam wherein the current insulation value is R-5 with a fiber insulator between the overlapping two panel edges to minimize thermal bridging, removable interior side shelves to accommodate 6-pack “Nursery Style” seed starter pots, drain controlled tray with removable planter/window box liners, interior lights, each PSMG is capable (with different capacity options) of producing 5V USB, 12V DC, and 110V AC. The “Garden Genie” is a hardware and software system that can collect and manage data in a modular greenhouse environment and send and receive that data via Wi-Fi, Bluetooth or CAT5 to a nearby router for use in a local computer or mobile device, and beyond to an online aggregator web site, and wherein data management includes one or more of the following:
Wi-Fi Bluetooth or CAT5 enabled
Webcam to record images for time-elapsed video
Powered by DC solar or AC
Temperature
Humidity
Light level (by leaves)
Soil moisture
pH
carbon dioxide
soil temperature
water temperature (in container)
exterior temperature
exterior humidity
uses
i. automated changes to greenhouse conditions
ii. human can review data and make changes
iii. share data with others
iv. analyze and design customized programs
v. report on history.

6. The greenhouse of claim 2 wherein the frame is collapsible.

7. The modular greenhouse system of claim 2 wherein the aluminum structure is a T-slot frame.
